(19) United States
(12) Patent Application Publication
(10) Pub. No.: US 2007/0082080 A1
(43) Pub. Date: Apr. 12, 2007

(54) Method and apparatus for casting concrete mix

(75) Inventor: Leo Sandqvist, Forssa (FI)

Correspondence Address: BUCHANAN, INGERSOLL & ROONEY PC, POST OFFICE BOX 1404, ALEXANDRIA, VA, 22313-1404, US

(73) Assignee: Elematic Oy Ab, Toijala (FI)

(21) Appl. No.: 11/543,885

(22) Filed: Oct. 6, 2006

(30) Foreign Application Priority Data
Oct. 12, 2005 (FI) 20051027

(51) Int. Cl. B28B 1/08

(52) U.S. Cl. 425/456; 264/69

(57) ABSTRACT

A method and an apparatus for casting thixotropic concrete mix substantially in a horizontal slipforming process, the concrete mix in said method being fed through a limited cross-section to form a concrete product of a desired form, whereby the concrete mix is fed to a space to be vibrated under pressure before it is led to the limited cross-section, the concrete mix being kept plastic in said space by means of vibrating in order to secure the complete filling of the limited cross-section.

The present invention relates to casting of concrete mix substantially with a horizontal slipforming process. More precisely, the invention relates to a method and an apparatus for casting of thixotropic concrete mix.

When casting with traditional extruder and slipformer type casting machines, the casting mold is formed by a casting bed and side walls and an upper plate moving progressively with the casting apparatus and forming the cross-section of the product to be cast into a desired shape and size. When the casting machine proceeds, the side walls and the upper plate, and if necessary the elements forming eventually one or a plurality of hollow cores into the product to be cast, perform movement to compact the concrete mix. The ready-cast product remains on the casting bed for hardening. Because the cast fresh slab remains in its final form resting on the casting bed, the concrete mix to be used in the solutions of prior art must be of low-slump type.

The low-slump concrete used in the solutions of prior art exerts strong wearing to the wear parts of the slipforming apparatus, like feed screws and hollow-core forming elements, thus causing the need to change these wear parts relatively often. In connection with the change of the wear parts, also the casting process of the production plant must be interrupted for the duration of the change.

According to the present invention, a slipforming apparatus for the slipforming process is provided, said slipforming apparatus having a simple construction including only a few wear parts. In addition, the slipforming apparatus according to the invention is provided for casting of thixotropic concrete mix, whereby significantly less wearing is exerted to the wear parts than when using the traditional low-slump concrete mix.

Thixotropic concrete mix in this connection refers to concrete mix that upon working of the mix changes to be more plastic and after the working stops, adopts immediately more low-slump properties.

More precisely, the method according to the present invention is characterized by what is stated in the characterizing part of claim 1, and the apparatus according to the present invention is characterized by what is stated in the characterizing part of claim 2.

The invention will be described by way of example in more detail in the following with reference to the enclosed drawing, wherein

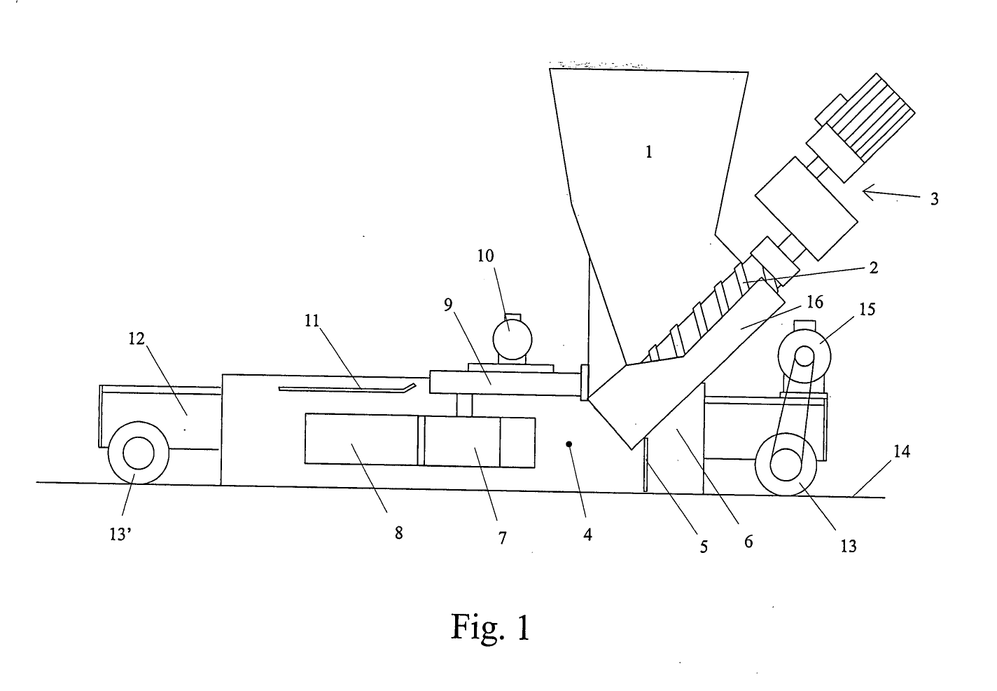

FIG. 1 shows schematically one slipforming apparatus in accordance with the invention.

The essential parts of the slipforming apparatus shown in FIG. 1 are: concrete mix tank 1, feed screw 2, drive equipment of feed screw 3, pressure chamber 4, front plate of the pressure chamber 5, side walls 6, hollow-core tube 7, following mandrel 8, vibrating beam 9, vibrator 10, surface leveling plate 11, frame of the slipforming apparatus 12, wheels 13, 13′ of the slipforming apparatus, casting bed 14, drive motor 15 and chute 16 of the slipforming apparatus. The apparatus shown in the FIGURE is meant for casting of hollow-core slabs or balks.

When using the slipforming apparatus shown in FIG. 1, thixotropic concrete mix is fed from the concrete mix tank 1 to one or a plurality of feed screws 2. The feed screws 2 extrude the concrete mix under pressure to the pressure chamber 4 defined by the casting bed 14, front plate 5, side walls 6 attached to the frame 12 and the vibrating beam 9, to which also the front end of the hollow core tube 7 can be extended, if necessary. Each feed screw 2 is located in a chute 16 that in the forward part of the feed screw leads concrete mix to the feed screw, and in the proceeding direction of the screw the chute forms a pipe around the feed screw, thus providing an adequate feeding pressure of the concrete mix to the pressure chamber. The concrete mix is compacted in the pressure chamber 4 as well as in the mold defined by the casting bed 14, side walls 6 and the vibrating beam 9, following the pressure chamber, by removing air from it by vibrating with the vibrator 10 by means of the vibrating beam 9 and the hollow-core tube 7 connected thereto. This vibration under pressure also keeps the concrete mix plastic in the pressure chamber 4. If necessary, also the side plates 6 can do the vibrating. After the vibrating stage, the forming of the hollow core into the product to be cast is secured by means of a following mandrel connected with vibration dampers to the hollow core tube 7. The upper surface of the hollow-core product to be cast is leveled by means of a surface leveling plate 11.

During the casting, the apparatus proceeds along the casting bed on the wheels 13, 13′ supporting the frame 12, at least a pair of which being driven by the drive motor 15.

Unlike in the traditional extruder slipforming apparatuses, the feeding of the concrete mix under pressure does not significantly cause any reacting force driving on the slipforming apparatus.

The ready-cast product remains on the casting bed 14 for hardening.

The solution according to the present invention is meant for casting of thixotropic concrete mix with a continuous slipform casting. The slump value of this kind of a thixotropic concrete mix ranges from 4 to 10 cm in the plastic state, in other words while being mixed or vibrated. The perfect filling of the casting mold is provided by this kind of thixotropic concrete mix, while being extruded by means of the feed screw under vibration, but after the vibration stops, the starting stiffening of the mass makes the form of the hollow cores or T-beams remain while the ready-cast product is hardening on the casting bed.

The solution according to the invention is not limited to the use of traditional thixotropic concrete mix only, but it can also be used for casting thixotropic special concrete mixes like for example thixotropic fibre-reinforced concrete mix as well as other thixotropic special concrete mixes.

In addition to the hollow-core slabs, the solution according to the invention can also be used for casting of solid slabs with no hollow-cores for example by removing the hollow core forming elements from the apparatus shown in the FIGURE. By changing the cross-sectional form of the mold, the solution according to the invention can also be used for casting of for example T-beams and ledgers.

The solution according to the invention can also be implemented with a fixed casting station, where by the casting apparatus is located in the fixed casting station, but the casting bed moves with respect to the casting station. Thereby the movable casting bed moves the ready product out of the fixed casting station and the ready-cast product remains resting on the casting bed.

1. A method for casting thixotropic concrete mix with a substantially horizontal slipforming process, the concrete mix in said method being fed through a limited cross section to form a concrete product of a desired shape, by means of feeding elements feeding the concrete mix substantially from a direction differing from the casting direction, wherein the concrete mix is fed to a space to be vibrated under pressure before it is led to the limited cross section, the concrete mix being kept plastic in said space by means of vibrating in order to secure the complete filling of the limited cross-section.

2. An apparatus for casting thixotropic concrete substantially with a horizontal slipforming process, said apparatus comprising means (1, 2, 3) for feeding the concrete mix to the limited cross section (14, 6, 9) from a direction substantially differing from the casting direction, wherein the apparatus comprises a pressure chamber (4) and means for vibrating the concrete mix in the pressure chamber.

3. An apparatus according to claim 2, wherein the apparatus comprises means (7, 8) for forming one or a plurality of hollow-cores into the product to be cast.

4. An apparatus according to claim, wherein the apparatus comprises a casting apparatus movable on the casting bed (14).

5. An apparatus according to claim 4, wherein the apparatus comprises wheels (13, 13′) and a drive motor (15) for transporting the apparatus along the casting bed.

6. An apparatus according to claim 2, wherein the apparatus comprises a fixed casting station and a casting bed (14) movable with respect to the casting station.

7. An apparatus according to claim 2, wherein the products to be cast by means of the apparatus include a hollow-core slab, a solid slab, a T-balk and a ledger.

8. An apparatus according to claim 3, wherein the apparatus comprises a casting apparatus movable on the casting bed (14).

9. An apparatus according to claim 8, wherein the apparatus comprises wheels (13, 13′) and a drive motor (15) for transporting the apparatus along the casting bed.

10. An apparatus according to claim 3, wherein the apparatus comprises a fixed casting station and a casting bed (14) movable with respect to the casting station.

11. An apparatus according to claim 3, wherein the products to be cast by means of the apparatus include a hollow-core slab, a solid slab, a T-balk and a ledger.

12. An apparatus according to claim 4, wherein the products to be cast by means of the apparatus include a hollow-core slab, a solid slab, a T-balk and a ledger.

13. An apparatus according to claim 5, wherein the products to be cast by means of the apparatus include a hollow-core slab, a solid slab, a T-balk and a ledger.

14. An apparatus according to claim 6, wherein the products to be cast by means of the apparatus include a hollow-core slab, a solid slab, a T-balk and a ledger.

15. An apparatus according to claim 8, wherein the products to be cast by means of the apparatus include a hollow-core slab, a solid slab, a T-balk and a ledger.

16. An apparatus according to claim 9, wherein the products to be cast by means of the apparatus include a hollow-core slab, a solid slab, a T-balk and a ledger.

17. An apparatus according to claim 10, wherein the products to be cast by means of the apparatus include a hollow-core slab, a solid slab, a T-balk and a ledger.
